(19) United States
(12) Patent Application Publication
(10) Pub. No.: US 2008/0198140 A1
(43) Pub. Date: Aug. 21, 2008

(54) Image display apparatus with image entry function

(75) Inventors: Masayoshi Kinoshita, Hachioji (JP); Hiroshi Kageyama, Hachioji (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 12/000,609

(22) Filed: Dec. 14, 2007

(30) Foreign Application Priority Data
Feb. 20, 2007 (JP) 2007-039272

(51) Int. Cl. G06F 3/041

(52) U.S. Cl. 345/173

(57) ABSTRACT

An image display apparatus with image entry function of high accuracy enabling high-speed direct screen input without decreasing a pixel aperture ratio. Data lines of thin-film transistors which do not receive light and storage lines are connected to respective selector switches. The selector switches are turned on and off by a switching signal supplied through a switching line from a control circuit. The conveyance of a drive signal and a video signal supplied from a gate line driving circuit and a data line driving circuit and the conveyance of a light signal to an X address detection circuit and a Y address detection circuit are switched by turning on and off the selector switches.

### CLAIM OF PRIORITY

The present application claims priority from Japanese application JP 2007-039272 filed on Feb. 20, 2007, the content of which is hereby incorporated by reference into this application.

### FIELD OF THE INVENTION

The present invention relates to an image display apparatus incorporating an optical sensor in a display panel, and in particular, relates to an image display apparatus with image entry function of high speed and high accuracy enabling direct screen input without decreasing a pixel aperture ratio.

### BACKGROUND OF THE INVENTION

An image display apparatus with image entry function in which information is inputted by a touch operation (hereinafter referred to simply as a touch) of a user's finger or the like on a screen is used in a touch-sensitive portable terminal such as a PDA and in a stationary customer guiding terminal such as an automatic reception machine. For the image display apparatus having such a screen touch input function, there are known a method for detecting a resistance change or capacitance change of a portion pressed by a touch, a method for detecting a light quantity change of a portion shaded by a touch, and the like.

Particularly, in recent years, there has been developed a method for detecting an external-light quantity change in a pixel structure constituting a screen to detect the coordinates of a touched portion. For example, JP-A No. 2005-129948 discloses that a light sensing element (light sensor) is formed of a thin-film transistor (TFT) in each pixel of a liquid crystal display panel constituting a liquid crystal display device.

FIG. 24 is an equivalent circuit illustrating a conventional pixel configuration of a general liquid crystal display panel in which a light sensor is formed in each pixel. This liquid crystal display panel, which is disclosed in JP-A No. 2005-129948, includes a plurality of gate lines (GL), a plurality of data lines (DL), a plurality of first switching elements (Q1) each electrically connected to a gate line (GL) and a data line (DL), a plurality of liquid crystal capacitors (CLC) and first storage capacitors (CST1) each connected to a first switching element (Q1). Each pixel further includes a first voltage line (VL1), a second voltage line (VL2), a second switching element (TS1) for detecting the strength of external light L and converting it into electric current, a second storage capacitor (CST2) for storing electric charge formed by electric current supplied from the second switching element (TS1), a third switching element (TS2) for outputting electric charge stored in the second storage capacitor (CST2), and a readout line (ROL). The second switching element (TS1), the second storage capacitor (CST2), and the third switching element (TS2) form a light sensing unit.

### SUMMARY OF THE INVENTION

The light sensor configuration disclosed in JP-A No. 2005-129948 requires a large number of elements including thin-film transistors in each pixel, which decreases the aperture ratio of the pixel for display and increases power consumption. The decrease in the aperture ratio reduces the brightness of the screen, and the increase in power consumption reduces operating time particularly in a portable terminal. Further, light leakage currents of a plurality of light detecting elements arranged in the horizontal direction in an area defined by the gate line, the data line, and the readout line are sequentially read out through switching elements in the order of lines. Accordingly, the time required to obtain two-dimensional light signals increases as the number of light detecting elements and switching elements increases. Thus, the higher the resolution is, the slower the detection speed is.

It is an object of the present invention to provide an image display apparatus with image entry function of high speed and high accuracy enabling direct screen input without decreasing a pixel aperture ratio.

In order to attain the above object, representative configuration and operation according to the invention will be described below, taking a liquid crystal display device as an example. In an image display apparatus with image entry function according to the invention, a light sensor composed of a thin-film transistor is formed in the following configuration and operation in a pixel area over an insulating substrate such as a glass substrate.

(1) The drain electrode or source electrode (drain electrode in this example) of a thin-film transistor for use as a switch (a switch TFT) which is shaded from light incident through a display screen is connected to the source electrode or drain electrode (source electrode in this example) of a thin-film transistor for use as a light sensor (a light detection TFT) which receives light incident through the display screen, so that both TFTs are connected in series.
(2) The source electrode or drain electrode of the light detection TFT is connected to a storage capacitor and a pixel electrode.
(3) The gate electrode of the light detection TFT is connected to a sensor control line, and the gate electrode of the switch TFT is connected to a gate line for pixel selection.
(4) The drain electrode or source electrode (source electrode in this example) of the switch TFT is connected to a data line.
(5) The drain electrode or source electrode (drain electrode in this example) of the light detection TFT is connected to one electrode of the storage capacitor and the pixel electrode.
(6) The other electrode of the storage capacitor is connected to a storage line.
(7) The data line and the storage line (or common line) convey a display signal and a sense signal of the light sensor.
(8) A selector switch is connected to respective one ends of the data line and the storage line (or common line) which convey the sense signal of the light sensor, and appropriately switches the conveyance of the display signal and the sense signal of the light sensor.
(9) Sense signals of light sensors arranged in a vertical direction are conveyed to an X address detection circuit through the data line, and sense signals of light sensors arranged in a horizontal direction are conveyed to a Y address detection circuit through the storage line (or common line).
(10) Based on output signals resulting from the X address detection circuit and the Y address detection circuit performing A/D conversion on sense signals, the presence or absence of a touch is determined.

The source electrode and the drain electrode of a thin-film transistor (TFT) are replaced with each other during the operation of a display panel. However, for the convenience of description, the source electrode and the drain electrode are fixed in the description below. Further, in place of the storage line, a common line which is the feeder line of a counter electrode can be used.

Although the invention is suitable for an active-matrix liquid crystal display device, the invention is applicable to an active-matrix organic EL display device and other similar display devices and light sensor applied equipment. A representative configuration example according to the invention will be described below.

In an image display apparatus with image entry function according to the invention, information is inputted by a touch on a pixel area of a screen formed over an insulating substrate. Each pixel in the pixel area composed of a plurality of pixels constituting the screen includes a first thin-film transistor for use as a pixel switch which is shaded from irradiation of light incident through the screen, a second thin-film transistor for use as a light sensor which receives the light, a storage capacitor, and a pixel electrode, on the principal surface of the insulating substrate.

Further, the drain electrode or source electrode of the first thin-film transistor is connected to the source electrode or drain electrode of the second thin-film transistor, and the drain electrode or source electrode of the second thin-film transistor is connected to one electrode of the storage capacitor and the pixel electrode.

Further, the image display apparatus includes a gate line for pixel selection connected to the gate electrode of the first thin-film transistor, a sensor control line connected to the gate electrode of the second thin-film transistor, a data line connected to the source electrode or drain electrode of the first thin-film transistor, and a storage line connected to the other electrode of the storage capacitor.

In the image display apparatus, the data line and the storage line convey a display signal to be applied to the pixel electrode and a sense signal of the second thin-film transistor.

The image display apparatus according to the invention includes a selector switch, connected to respective one ends of the data line and the storage line, for switching conveyance of the display signal and the sense signal.

The image display apparatus according to the invention includes an X address detection circuit which receives sense signals of second thin-film transistors arranged in a vertical direction in the pixel area through the data line, and a Y address detection circuit which receives sense signals of second thin-film transistors arranged in a horizontal direction in the pixel area through the storage line.

The image display apparatus according to the invention includes a control circuit which determines the presence or absence of a touch and extracts a position address thereof, based on an output of the X address detection circuit and an output of the Y address detection circuit.

According to the invention, since the data line and the storage line (or common line) are also used as the signal lines of the light sensor, the pixel structure is simplified, which can suppress a decrease in the aperture ratio of the pixel associated with the incorporation of the light sensor into the image display apparatus. Further, since light sensor signals are conveyed in the vertical (Y) and horizontal (X) directions, there is no need to perform region segmentation in the vertical (Y) direction to sequentially read out signals, and the information (address) of a two-dimensional touched position can be obtained based on the light sensor signals read in the vertical and horizontal directions.

Further, the suppression of a decrease in the aperture ratio can reduce an increase in the power consumption of the backlight associated with the incorporation of the light sensor into the image display apparatus, and the reduction of detection time can improve touch detection accuracy.

### BRIEF DESCRIPTION OF THE DRAWINGS

FIG. 1 is a developed perspective view of a liquid crystal display device with image entry function according to a first embodiment of the invention;

FIG. 2 is a sectional view of one pixel of the liquid crystal display device with image entry function shown in FIG. 1;

FIGS. 3A and 3B are explanatory views illustrating the relationship between the illuminance of light irradiating a thin-film transistor (TFT) and the drain current, in which FIG. 3A is a graph showing the dependence of drain current on the amount of light applied to the TFT, and FIG. 3B is a schematic view showing the light irradiation and the drain current of the TFT;

FIG. 4 is a circuit configuration diagram of the image display apparatus, according to the first embodiment of the invention;

FIG. 5 is a drive timing chart of the image display apparatus shown in FIG. 4, according to the first embodiment;

FIG. 6 is a circuit diagram of the X address detection circuit and the Y address detection circuit shown in FIG. 4;

FIG. 7 is a block diagram of the image display apparatus according to the invention;

FIG. 8 is a circuit configuration diagram of the image display apparatus, according to a second embodiment of the invention;

FIG. 9 is a timing chart illustrating the operation of the image display apparatus, according to the second embodiment of the invention;

FIG. 10 is a circuit configuration diagram of the image display apparatus, according to a third embodiment of the invention;

FIG. 11 is a circuit configuration diagram of the image display apparatus, according to a fourth embodiment of the invention;

FIG. 12 is a circuit configuration diagram of the image display apparatus, according to a fifth embodiment of the invention;

FIG. 13 is a circuit configuration diagram of the image display apparatus, according to a sixth embodiment of the invention;

FIG. 14 is a circuit configuration diagram of the image display apparatus, according to a seventh embodiment of the invention;

FIG. 15 is a circuit configuration diagram of the image display apparatus, according to an eighth embodiment of the invention;

FIG. 16 is a circuit configuration diagram of the image display apparatus, according to a ninth embodiment of the invention;

FIG. 17 is a circuit diagram illustrating a first configuration example of the horizontal and vertical sensor circuits applied to embodiments of the invention;

FIG. 18 is a circuit diagram illustrating a second configuration example of the horizontal and vertical sensor circuits applied to embodiments of the invention;

FIG. 19 is a circuit diagram illustrating a third configuration example of the horizontal and vertical sensor circuits applied to embodiments of the invention;

FIG. 20 is a circuit diagram illustrating a fourth configuration example of the horizontal and vertical sensor circuits applied to embodiments of the invention;

FIG. 21 is a circuit diagram illustrating a fifth configuration example of the horizontal and vertical sensor circuits applied to embodiments of the invention;

FIG. 22 is an explanatory view illustrating a display screen with a touch panel for use on the image display apparatus according to the invention;

FIG. 23 is a schematic external view showing a mobile electronic device to which the image display apparatus according to the invention is applied; and

FIG. 24 is an equivalent circuit illustrating a conventional pixel configuration of a general liquid crystal display panel in which a light sensor is formed in each pixel.

### DESCRIPTION OF THE PREFERRED EMBODIMENTS

Hereinafter, preferred embodiments of the present invention will be described in detail with reference to the accompanying drawings.

### First Embodiment

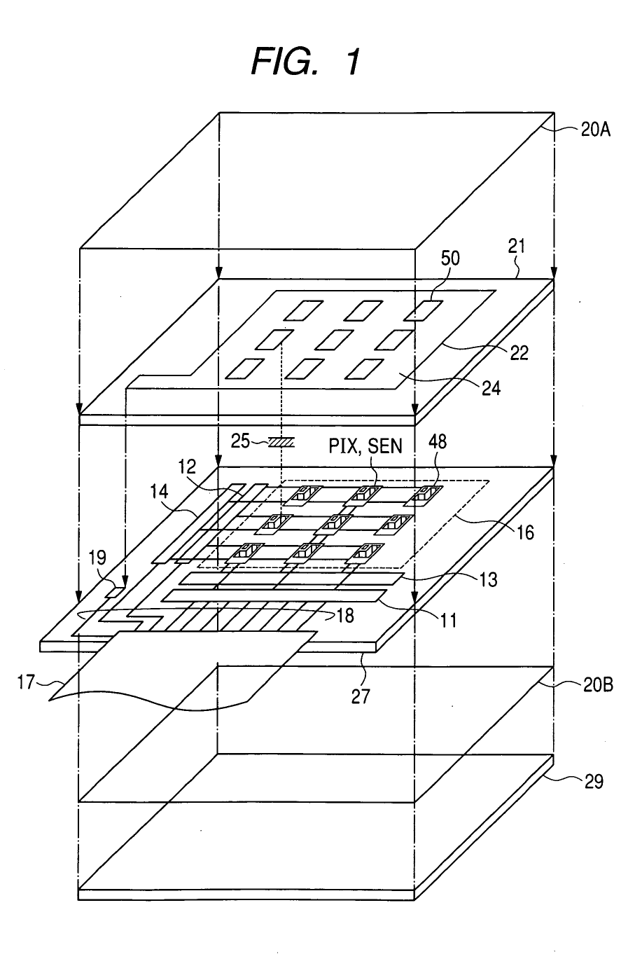

FIG. 1 is a developed perspective view of a liquid crystal display device with image entry function according to a first embodiment of the invention. In FIG. 1, there is a display area (pixel area) 16 in which a plurality of pixels (indicated by pixel electrodes 48) are matrix-arranged on the principal surface (inner surface on which thin-film transistors (TFT) etc. are formed) of a lower glass substrate 27 which is a first insulating substrate (TFT substrate). Pixels PIX which form the display area 16 have a light sensing function SEN as well as a display function. Further, there are, outside the pixel area 16 on the principal surface of the glass substrate 27, a data driver 11 connected to the source electrode or drain electrode (source electrode in this embodiment) of a switch TFT for pixel display (first thin-film transistor described later), a gate driver 12 which applies a selection signal to the gate electrode of a TFT for use as a pixel switch constituting a pixel, an X address detection circuit 13 which detects the horizontal-direction (X-direction) address of a pixel touched by a light detection TFT (second thin-film transistor described later), and a Y address detection circuit 14 which detects the vertical-direction (Y-direction) address thereof.

The data driver 11, the gate driver 12, the X address detection circuit 13, and the Y address detection circuit 14 are connected to a control circuit 15 disposed outside (described later), a data signal source, and an upper-level information processing circuit (host computer, not shown) via wiring 18 patterned on the lower glass substrate 27 and a flexible printed circuit board (FPC). The control circuit 15 can be also formed on the lower glass substrate 27.

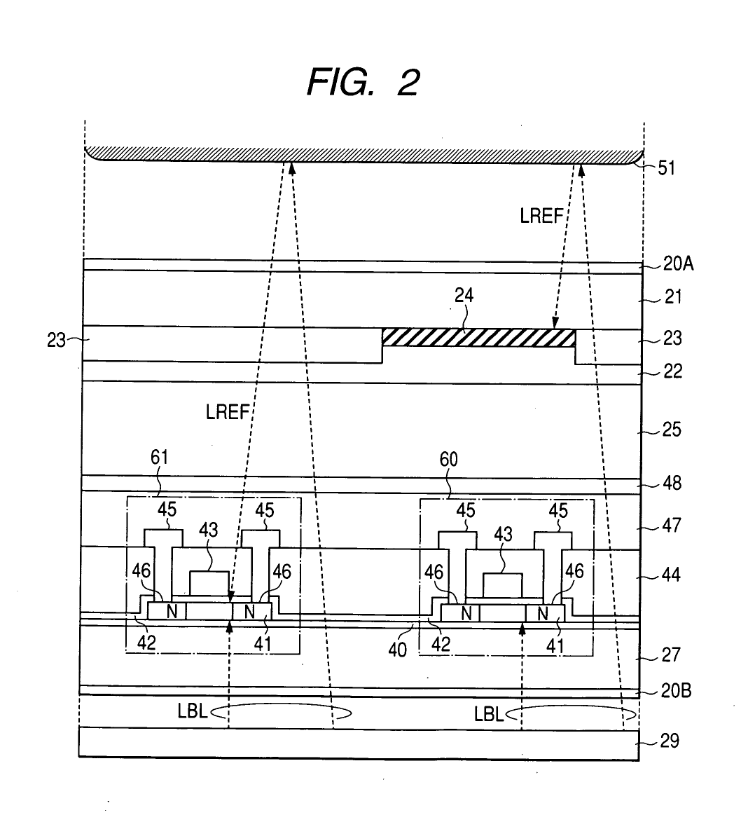

A plurality of color filters (indicated by a pixel aperture 50) corresponding to the pixels formed on the principal surface of the lower glass substrate 27 are formed, partitioned by a light shielding film (black matrix) 24, on the principal surface of an upper glass substrate 21 which is a second insulating substrate. Further, a counter electrode (common electrode) 22 is thickly formed thereon. Liquid crystal 25 is sealed in the gap between the principal surface of the upper glass substrate 21 and the principal surface of the lower glass substrate 27. At the interfaces between the pixel electrode 48 and the liquid crystal 25 and between the counter electrode 22 and the liquid crystal 25, alignment films (not shown) capable of liquid crystal orientation control are formed. The same applies to FIG. 2 and subsequent drawings. Counter electrode voltage is applied to the counter electrode 22 from a connection terminal 19 disposed on the lower glass substrate 27.

An upper polarizing plate 20A is attached on the top surface (observation surface) of the upper glass substrate 21, and a lower polarizing plate 20B is attached on the under surface (rear surface) of the lower glass substrate 27, thus constituting a liquid crystal display panel. Normally, the light absorption axis of the upper polarizing plate 20A and the light absorption axis of the lower polarizing plate 20B are cross-Nicol disposed. A backlight 29 is installed at the back side of the lower glass substrate 27 constituting the liquid crystal display panel.

In FIG. 1, the liquid crystal display panel in which the counter electrode 22 is disposed on the principal surface of the upper glass substrate 21 is used in the liquid crystal display device. However, even in the case of a liquid crystal display panel in which the counter electrode 22 is disposed on the principal surface of the lower glass substrate 27, the same configuration is applied to the pixel circuit PIX having the light sensing function SEN composed of the light detection TFT (second thin-film transistor) and the switch TFT (first thin-film transistor), except for electrode arrangement and electrode form.

FIG. 2 is a sectional view of one pixel of the liquid crystal display device with image entry function shown in FIG. 1 according to the first embodiment of the invention. The liquid crystal display device with image entry function has a light sensor (light detector) as image entry function. The light sensor is formed on the principal surface of the lower glass substrate 27 and composed of a light detection thin-film transistor (light detection TFT, sensor TFT, second thin-film transistor) 61 and a switch TFT (first thin-film transistor) 60. Further, the light detection TFT 61 and the switch TFT 60 also have the function of controlling pixel display.

FIG. 2 shows a state in which a finger or the like 51 (hereinafter referred to as a finger) of an operator (user) touches the pixel. The light detection TFT 61 formed on the principal surface of the lower glass substrate 27 is disposed under a color filter 23 formed on the principal surface of the upper glass substrate 21. Light LBL from the backlight 29 is reflected by the finger 51 into reflected light LREF, which passes through the upper glass substrate 21 and the color filter 23 and falls on the light detection TFT 61. Further, a part of the light LBL from the backlight 29 falls on the underside of the light detection TFT.

Similarly, the switch TFT 60 formed on the principal surface of the lower glass substrate 27 is disposed under the black matrix 24 formed on the principal surface of the upper glass substrate 21. In the switch TFT 60, the reflected light LREF resulting from the finger 51 reflecting the light LBL from the backlight 29 is blocked by the black matrix 24; therefore, only the light LBL from the backlight falls on the switch TFT 60.

In FIG. 2, reference numeral 40 denotes an insulating film (base film made of silicon oxide or silicon nitride); 41, a polysilicon layer; 42, a gate insulating layer; 43, a gate electrode; 44, an interlayer insulating film; 45, a metal layer for a source electrode or a drain electrode; 46, a contact hole; and 47, planarizing insulating film.

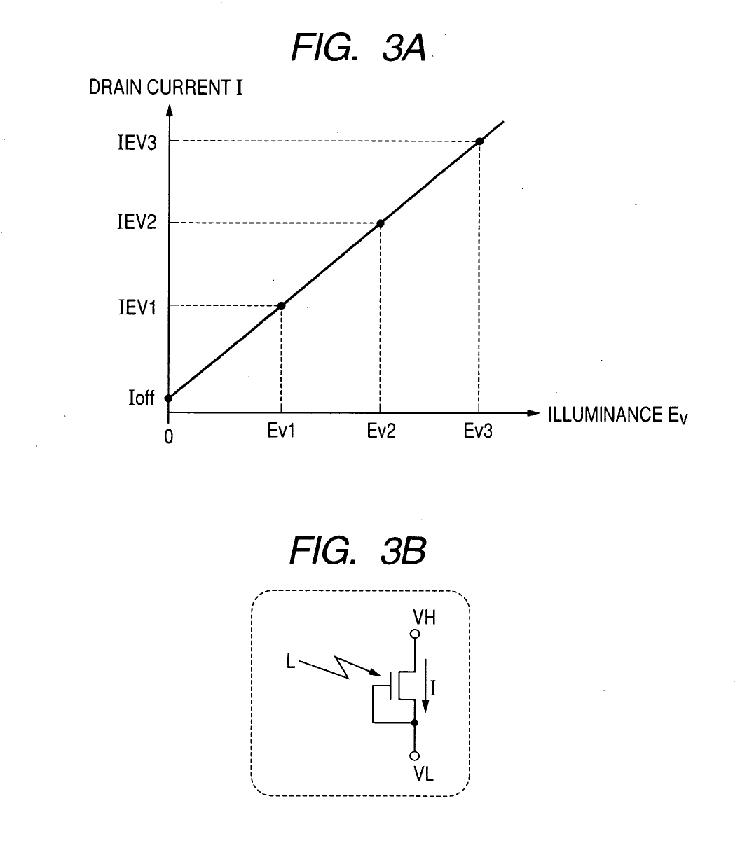

FIGS. 3A and 3B are explanatory views illustrating the relationship between the illuminance of light irradiating a thin-film transistor (TFT) and the drain current. FIG. 3A shows the dependence of drain current on the amount of light applied to the TFT. The horizontal axis represents the illuminance Ev of light L irradiating the TFT, and the vertical axis represents the drain current I of the TFT. FIG. 3B is a schematic view showing the light irradiation and the drain current of the TFT. As shown in FIG. 3B, a high potential VH is applied to the drain of the TFT and a low potential VL is applied to the source of the TFT, with the gate and source connected in a diode configuration, thereby causing a drain current Ioff due to dark current. Further, light energy generated by the irradiation of light L directly excites electrons in the channel of the TFT from a valence band to a conduction band, which flows the drain current I depending on the amount of light.

Let the illuminance when light is not applied to the TFT be equal to 0. As the illuminance of the light L applied to the TFT increases to EV1, EV2, and EV3, the drain current I increases to Ioff, IEV1, IEV2, and IEV3 in proportion to the illuminance of the light L. The image display apparatus according to this embodiment enables an input function such as a touch panel function by utilizing the characteristic that the current depending on the amount of light flows in the TFT and manufacturing TFTs on the glass substrate.

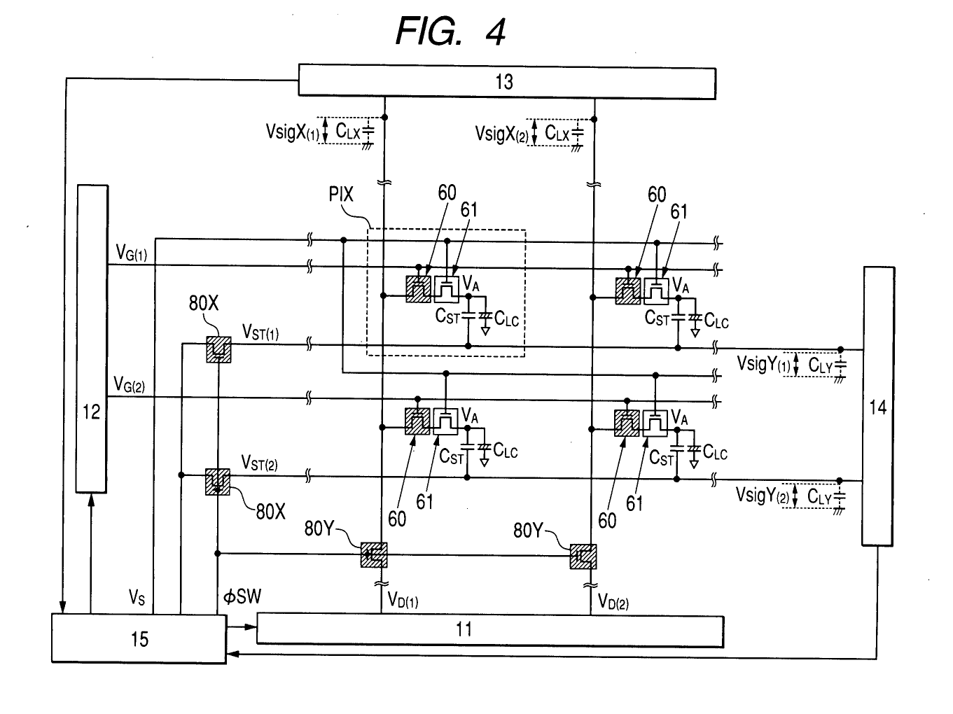

FIG. 4 is a circuit configuration diagram of the image display apparatus, according to the first embodiment of the invention. In FIG. 4, a 2×2 pixel matrix is shown, for the convenience of description. In FIG. 4, thin-film transistors indicated by hatched squares are the switch TFT, i.e., the first thin-film transistor 60 which does not receive light as described in FIG. 2, and thin-film transistors indicated by open squares are the sensor TFT (light detection TFT). The reference symbols of lines in FIG. 4 are represented by the corresponding signal voltages on the lines (The same applies to subsequent drawings). Data lines VD(1) and VD(2) of the first thin-film transistors 60 which do not receive light as described in FIG. 2 are connected to selector switches 80Y, and storage lines V_{ST(1)} and V_{ST(2)} are connected to selector switches 80X. The selector switches 80X and the selector switches 80Y are turned on and off by a switching signal φSW supplied through a switching line V_{Sk} from the control circuit 15. The conveyance of a drive signal and a video signal supplied from the gate line driving circuit 12 and the data line driving circuit 11 and the conveyance of a light signal to the X address detection circuit 13 and the Y address detection circuit 14 are switched by turning on and off the selector switches.

Next, the pixel circuit PIX will be described. The light detection TFT 61 which receives light incident through the screen (upper glass substrate 21) of the liquid crystal display panel and the switch TFT 60 which does not receive light incident through the screen of the liquid crystal display panel due to blockage by the black matrix or the like are connected in series. The source electrode (or drain electrode, the same applies hereinafter) of the light detection TFT 61 is connected to an auxiliary capacitor CST and a pixel electrode (ITO). The gate electrode of the light detection TFT 61 is connected to a sensor line VS. The gate electrode of the switch TFT 60 is connected to a gate line VG(1). The drain electrode of the switch TFT 60 is connected to the data line VD(1). One end of the auxiliary capacitor CST is connected to the storage line VST(1). Parasitic capacitors CLX and CLY exist on the data lines VD(1) and VD(2) and the storage lines VST(1) and VST(2).

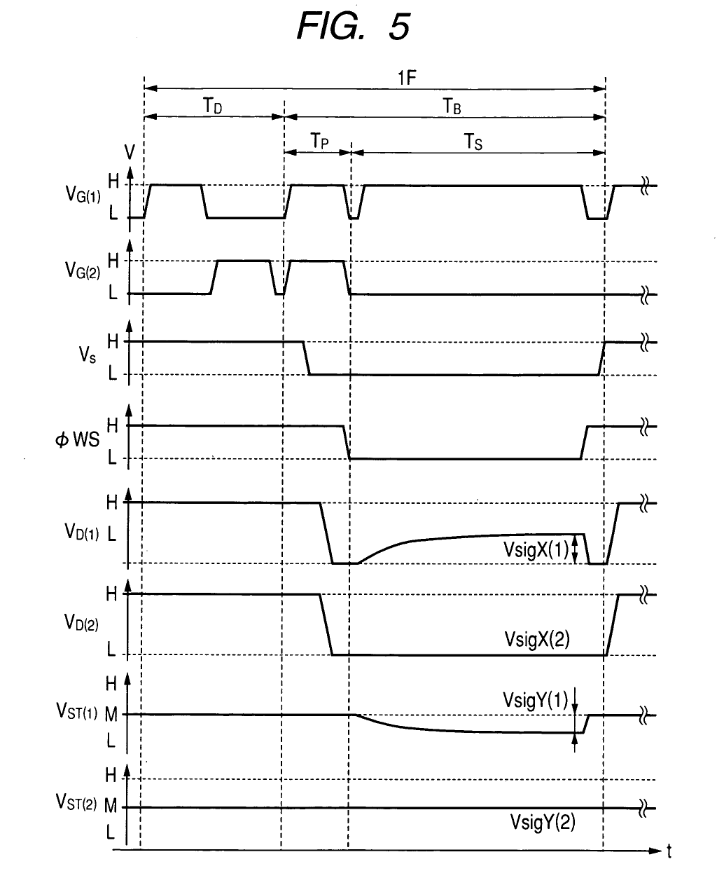

FIG. 5 is a drive timing chart of the image display apparatus shown in FIG. 4, according to the first embodiment. Normally, the image display apparatus-outputs a video signal corresponding to one screen in one frame period 1F (60 Hz). The frame period is divided into a display period T_{D} and a blanking period T_{B}. Touch sensing according to this embodiment is performed in the blanking period T_{B}. The blanking period T_{B} is divided into a precharge period T_{P} for initializing a pixel electrode potential VA and a sense period T_{S} for conveying the light signal of the light detection TFT to the X address detection circuit and the Y address detection circuit. First, the display period T_{D} will be described. When VG(1) and VG(2) become high (H) from low (L), the drain voltages VD(1) and VD(2) are taken in the respective pixel electrodes. At this time, VS and φSW remain high. The data line driving circuit 11 supplies a video signal to the data lines VD(1) and VD(2) to display video on the screen.

Next, the precharge period T_{P} will be described. The drain line voltages VD(1) and VD(2), the gate line voltages VG(1) and VG(2), and the sense line voltage VS are high (H), so that the pixel electrode potential VA is initialized. Further, when the sense line voltage VS becomes low (L), the drain current I depending on the amount of light flows in the light detection TFT 61.

Next, the sense period T_{D} will be described. When φSW becomes low (L) from high (H), the data lines VD(1) and VD(2) and the storage lines VST(1) and VST(2) are cut off from the data line driving circuit 11 and the control circuit. Further, when the gate line voltages VG(1) and VG(2) become high (H) from low (L), a light current Isig generated in the light detection TFT 61 of each pixel is charged in the data-line parasitic capacitor CLX, and consequently a potential difference ΔVsigX(1) is conveyed to the X address detection circuit 13. At the same time, in accordance with the variation of the pixel electrode potential VA, a potential difference ΔVsigY(1) appears on the storage lines VST(1) and VST(2) through the pixel capacitor CST, and is conveyed to the Y address detection circuit 14. As the illuminance of light incident on the light detection TFT 61 increases, the potential difference increases, which leads to easier detection.

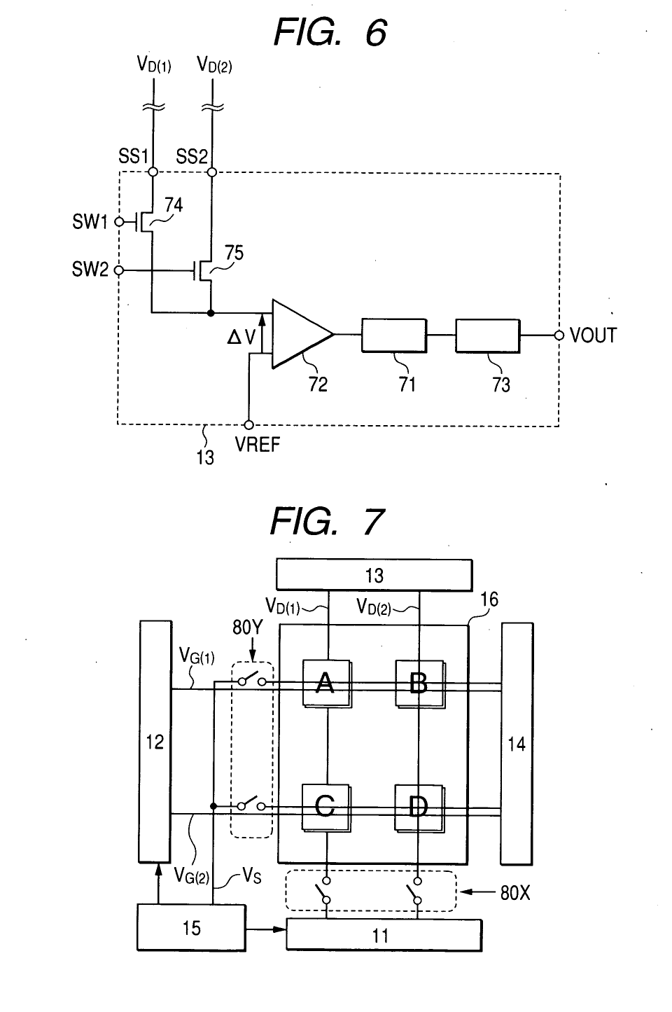

FIG. 6 is a circuit diagram of the X address detection circuit and the Y address detection circuit shown in FIG. 4. The Y address detection circuit 14 has the same configuration as that of the X address detection circuit 13. Therefore, to avoid repetitive description, only the X address detection circuit 13 will be described. This circuit is mainly composed of an amplifier 72 and an A/D converter 73.

Terminals SS1 and SS2 connected to the data lines VD(1) and VD(2) are connected to the amplifier 72 through a first selection switch 74 and a second selection switch 75 composed of thin-film transistors. Terminals SW1 and SW2 are connected to the respective gate electrodes of the first selection switch 74 and the second selection switch 75. The control circuit 15 shown in FIG. 4 controls the first selection switch 74 and the second selection switch 75. A differential voltage ΔV between a signal voltage VsigX and a reference voltage VREF is inputted to the amplifier 72, and the voltage amplified by the amplifier 72 is conveyed through a sample/hold circuit 71 to the A/D converter 73, which converts it into a digital signal which is outputted as a digital determination signal VOUT.

FIG. 7 is a block diagram of the image display apparatus according to the invention. The gate line driving circuit 12, the data line driving circuit 11, the X address detection circuit 13, and the Y address detection circuit 14 are formed on the glass substrate. Reference numerals V_{G(1)} and V_{G(2)} denote gate lines; VD(1) and VD(2), data lines; φSW, a switching signal supplied through a switching line V_{S}; and 80X and 80Y, selector switches. In FIG. 7, predetermined switch-shaped images of A, B, C, and D to be touched by a user are displayed in the display area.

When one of the switch-shaped images of A, B, C, and D on the screen is touched by a user, signal voltages VsigX(1), VsigX(2) and signal voltages VsigY(1), VsigY(2) in the circuit of FIG. 4 are conveyed to the X address detection circuit 13 and the Y address detection circuit 14. The X address detection circuit 13 and the Y address detection circuit 14 perform A/D-conversion thereon and output the determination signals VOUT to the control circuit 15, which determines the presence or absence of a touch and extracts the touch position (address).

According to the first embodiment, since the data line and the storage line (or common line) are also used as the signal lines of the light sensor, the pixel structure is simplified, which can suppress a decrease in the aperture ratio of the pixel associated with the incorporation of the light sensor into the image display apparatus, and thus can reduce an increase in the power consumption of the backlight associated with the incorporation of the light sensor into the image display apparatus. Further, since light signals are conveyed in the vertical (Y) and horizontal (X) directions, there is no need to perform region segmentation in the vertical (Y) direction to sequentially read out signals, and the information on a two-dimensional touched position can be obtained based on the light signals read in the vertical and horizontal directions, which leads to a reduction in detection time and thus can improve touch detection accuracy.

### Second Embodiment

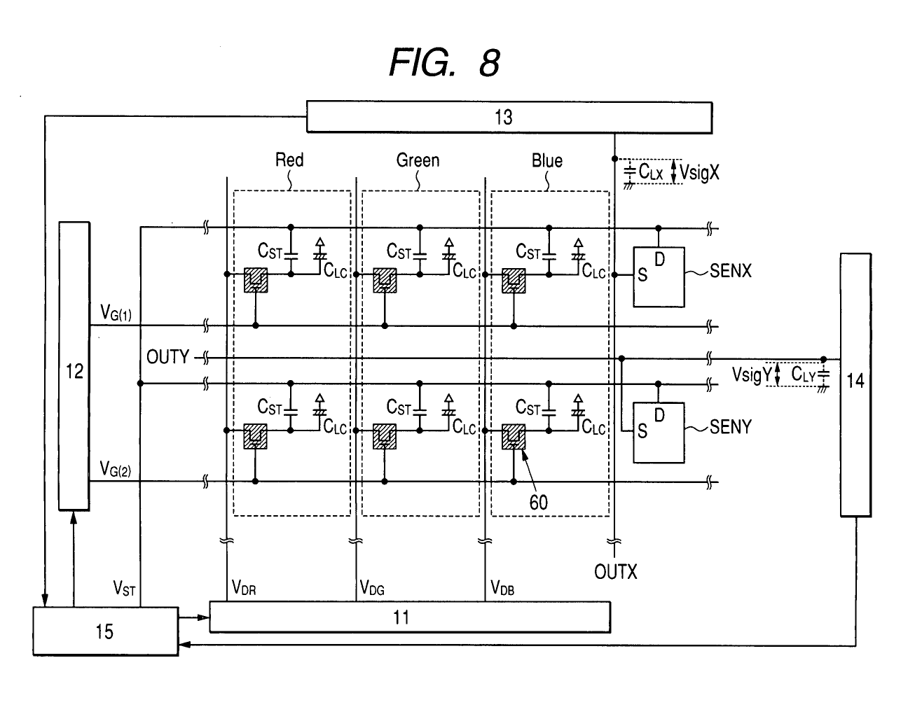

FIG. 8 is a circuit configuration diagram of the image display apparatus, according to a second embodiment of the invention. In the second embodiment, one pixel is composed of three RGB sub-pixels and a sensor circuit. In FIG. 8, for the convenience of description, pixels are arranged in two rows. A sub-pixel is composed of a switch TFT 60, a storage capacitor CST, and a liquid crystal capacitor CLC. The gate electrode of the switch TFT 60 is connected to a gate line V_{G(1)}. One end of the storage capacitor C_{ST} is connected to a storage line V_{ST}. This is the same configuration as the pixel circuit of an ordinary liquid crystal display device. The color filters of red, green, and blue are arranged in stripe shapes over the sub-pixels.

A horizontal sensor circuit SENX and a vertical sensor circuit SENY are disposed adjacent to the sub-pixel under the blue filter. These sensor circuits are composed of thin-film transistors (TFT). The drain (D) electrode of the horizontal sensor circuit SENX is connected to the storage line VST, and the source (S) electrode (or drain electrode) is connected to a signal line OUTX. A light current Isig is charged in the parasitic capacitor C_{LX} of the signal line OUTX, and consequently a voltage VsigX is conveyed to the X address detection circuit 13.

The drain (D) electrode (or source electrode) of the vertical sensor circuit SENY is connected to the storage line VST, and the source (S) electrode is connected to a signal line OUTY. A light current Isig is charged in the parasitic capacitor C_{LY} of the signal line OUTY, and consequently a voltage VsigY is conveyed to the Y address detection circuit 14. Thus, to obtain an X-direction address and a Y-direction address corresponding to a pixel on which touch reflected light LREF has fallen, based on the determination signals VOUT outputted from the X address detection circuit and the Y address detection circuit, the control circuit determines the presence or absence of a touch and extracts the touch position (address).

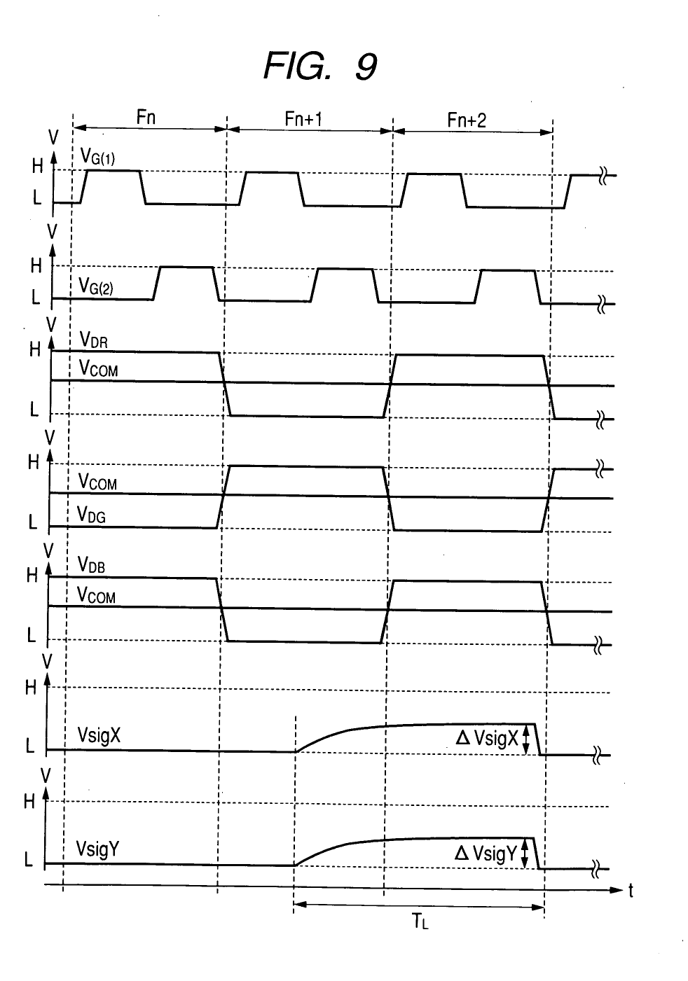

FIG. 9 is a timing chart illustrating the operation of the image display apparatus, according to the second embodiment of the invention. FIG. 9 shows pixel-circuit driving voltages V_{(G1)}, V_{(G2)}, V_{DR}, V_{DG}, V_{DB}, and V_{COM} and light signal voltages VsigX and VsigY. To simplify the description, the image display apparatus according to the invention employs a frame inversion diving scheme in which the polarity of an image is inverted for every frame in a TN-type liquid crystal of normally black mode. Accordingly, the polarities of voltages V_{DR}, V_{DG}, V_{DB} are inverted every frame period (nth frame Fn, (n+1)th frame Fn+1, (n+2)th frame Fn+2). During this time, the voltage V_{COM} is supplied to the drain electrodes (or source electrodes) of the horizontal sensor circuit SENX and the vertical sensor circuit SENY. During light irradiation, a light current Isig is read out onto the signal lines OUTX and OUTY and charged in the parasitic capacitors C_{LX} and C_{LY}, thus generating signal voltages ΔVsigX and ΔVsigY, which are conveyed to the X address detection circuit 13 and the Y address detection circuit 14, respectively.

According to the second embodiment as well, the pixel structure is simplified, which can suppress a decrease in the aperture ratio of the pixel associated with the incorporation of the light sensor into the image display apparatus, and thus can reduce an increase in the power consumption of the backlight associated with the incorporation of the light sensor into the image display apparatus. Further, since light signals are conveyed in the vertical (Y) and horizontal (X) directions, there is no need to perform region segmentation in the vertical (Y) direction to sequentially read out signals, and the information on a two-dimensional touched position can be obtained based on the light signals read in the vertical and horizontal directions, which leads to a reduction in detection time and thus can improve touch detection accuracy.

### Third Embodiment

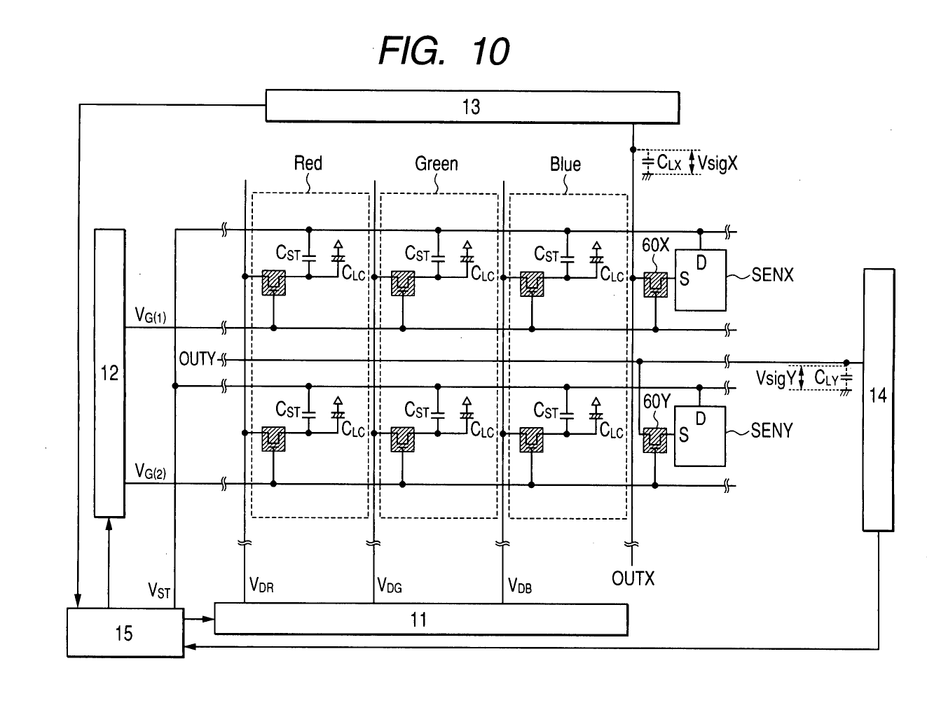

FIG. 10 is a circuit configuration diagram of the image display apparatus, according to a third embodiment of the invention. The third embodiment differs from the second embodiment only in that switches 60X and 60Y composed of TFTs are connected between the respective source electrodes (S) of the horizontal sensor circuit SENX and the vertical sensor circuit SENY and the respective signal lines OUTX and OUTY. In the following, only the different point will be described. The gate electrode of the horizontal switch 60X connected to the horizontal sensor circuit SENX is connected to the gate line V_{G(1)}. The source electrode is connected to the signal line OUTX.

The gate electrode of the vertical switch 60Y connected to the vertical sensor circuit SENY is connected to the gate line V_{G(2)}. The source electrode (or drain electrode) is connected to the signal line OUTY. The light current of a sensor circuit selected by the gate line driving circuit is read out onto the signal line, but the light current of a non-selected sensor circuit is not read out. This advantageously increases an S/N ratio as compared to the second embodiment and enables selection of a touch area. In the third embodiment, the gates of the switches 60X and 60Y are connected to the gate lines V_{G(1)} and V_{G(2)}; however, the connection is not limited thereto. For example, dedicated control lines and driving circuit for selecting a touch area can be newly provided independently of the drive of the pixel circuit for display.

According to the third embodiment as well, the pixel structure is simplified, which can suppress a decrease in the aperture ratio of the pixel associated with the incorporation of the light sensor into the image display apparatus, and thus can reduce an increase in the power consumption of the backlight associated with the incorporation of the light sensor into the image display apparatus. Further, since light signals are conveyed in the vertical (Y) and horizontal (X) directions, there is no need to perform region segmentation in the vertical (Y) direction to sequentially read out signals, and the information on a two-dimensional touched position can be obtained based on the light signals read in the vertical and horizontal directions, which leads to a reduction in detection time and thus can improve touch detection accuracy.

### Fourth Embodiment

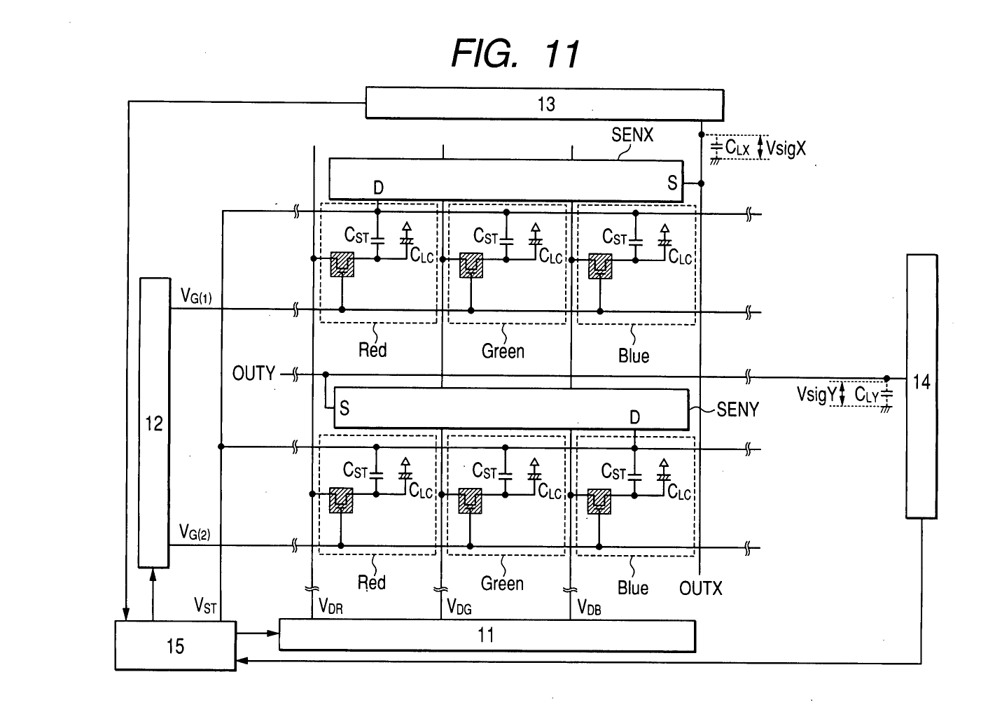

FIG. 11 is a circuit configuration diagram of the image display apparatus, according to a fourth embodiment of the invention. The fourth embodiment differs from the second embodiment in that the sensor circuits SENX and SENY are disposed below the filters of the sub-pixels under the red, green, and blue filters. The other configurations in the fourth embodiment are the same as those in the second embodiment, and thus their repetitive description is omitted here.

According to the fourth embodiment as well, the pixel structure is simplified, which can suppress a decrease in the aperture ratio of the pixel associated with the incorporation of the light sensor into the image display apparatus, and thus can reduce an increase in the power consumption of the backlight associated with the incorporation of the light sensor into the image display apparatus. Further, since light signals are conveyed in the vertical (Y) and horizontal (X) directions, there is no need to perform region segmentation in the vertical (Y) direction to sequentially read out signals, and the information on a two-dimensional touched position can be obtained based on the light signals read in the vertical and horizontal directions, which leads to a reduction in detection time and thus can improve touch detection accuracy.

### Fifth Embodiment

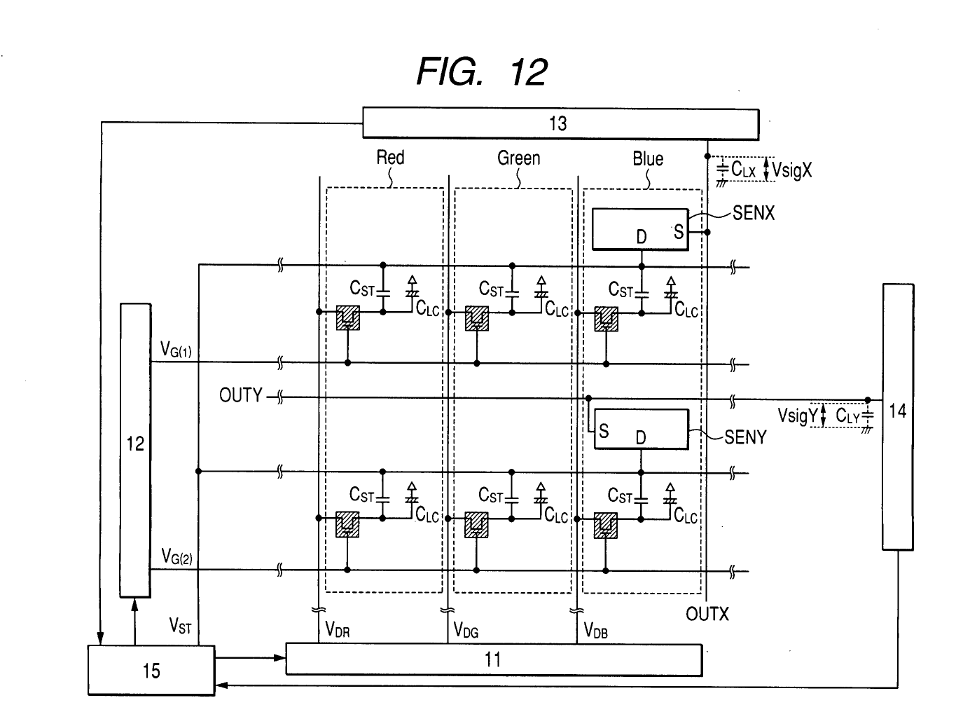

FIG. 12 is a circuit configuration diagram of the image display apparatus, according to a fifth embodiment of the invention. The fifth embodiment differs from the second embodiment in that the sensor circuits SENX and SENY are disposed under the blue filter. The sensor circuits SENX and SENY are composed of thin-film transistors (TFT) and therefore have higher sensitivity to short-wavelength light that has passed through the blue filter than light that passed through the red or green filter, which lead to an improvement in detection accuracy.

According to the fifth embodiment as well, the pixel structure is simplified, which can suppress a decrease in the aperture ratio of the pixel associated with the incorporation of the light sensor into the image display apparatus, and thus can reduce an increase in the power consumption of the backlight associated with the incorporation of the light sensor into the image display apparatus. Further, since light signals are conveyed in the vertical (Y) and horizontal (X) directions, there is no need to perform region segmentation in the vertical (Y) direction to sequentially read out signals, and the information on a two-dimensional touched position can be obtained based on the light signals read in the vertical and horizontal directions, which leads to a reduction in detection time and thus can improve touch detection accuracy.

### Sixth Embodiment

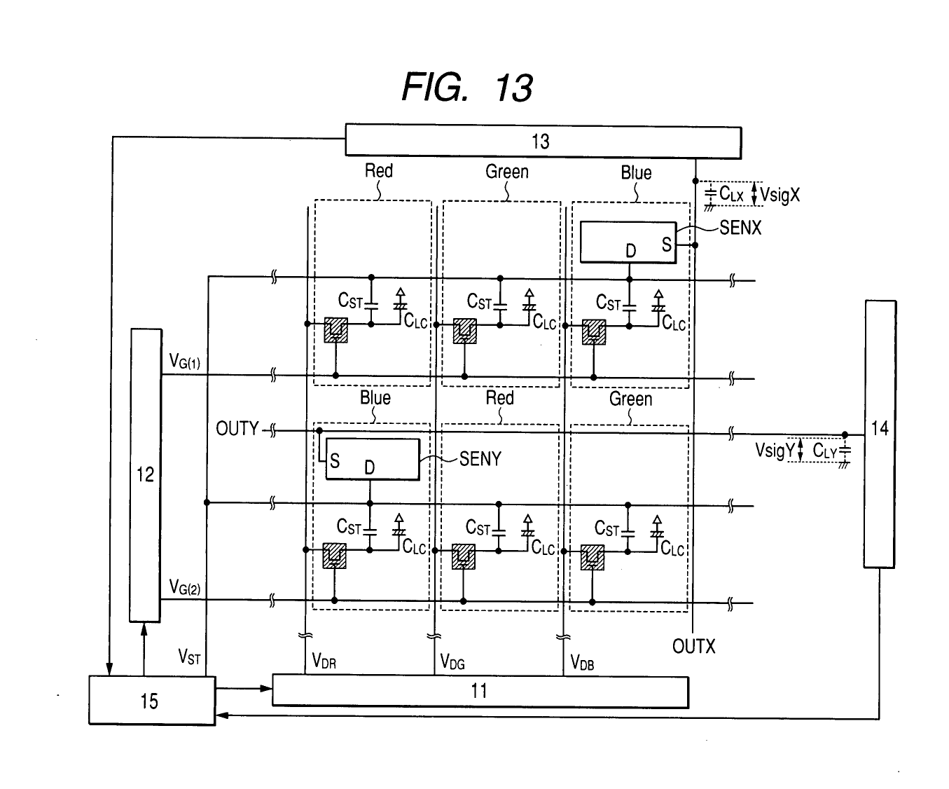

FIG. 13 is a circuit configuration diagram of the image display apparatus, according to a sixth embodiment of the invention. The fifth embodiment differs from the fifth embodiment in that the color filters of red, green, and blue are disposed in a mosaic arrangement instead of a stripe arrangement. That is, sub-pixels along the first horizontal line are disposed in the order of red, green, and blue, and sub-pixels along the first vertical line are disposed in the order of red, blue, and green, followed by red, blue, and green. The sensor circuits SENX and SENY are disposed under the blue filters.

According to the sixth embodiment, as in the case of the fifth embodiment, the pixel structure is simplified, which can suppress a decrease in the aperture ratio of the pixel associated with the incorporation of the light sensor into the image display apparatus, and thus can reduce an increase in the power consumption of the backlight associated with the incorporation of the light sensor into the image display apparatus. Further, since light signals are conveyed in the vertical (Y) and horizontal (X) directions, there is no need to perform region segmentation in the vertical (Y) direction to sequentially read out signals, and the information on a two-dimensional touched position can be obtained based on the light signals read in the vertical and horizontal directions, which leads to a reduction in detection time and thus can improve touch detection accuracy.

### Seventh Embodiment

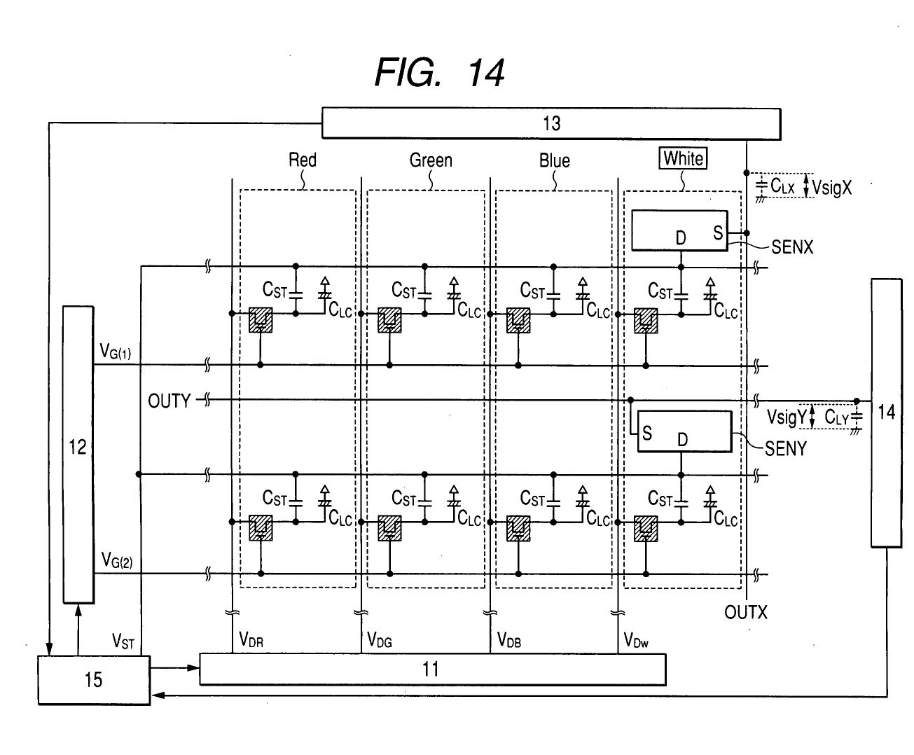

FIG. 14 is a circuit configuration diagram of the image display apparatus, according to a seventh embodiment of the invention. The seventh embodiment differs from the second embodiment in that the color filters of red, green, blue, and white are arranged in stripe shapes over four sub-pixels and the sensor circuits SENX and SENY are disposed under the white filter. The formation of the sensor circuits under the white filter increases the sensitivity of the light detection TFT.

According to the seventh embodiment, as in the case of the second embodiment, the pixel structure is simplified, which can suppress a decrease in the aperture ratio of the pixel associated with the incorporation of the light sensor into the image display apparatus, and thus can reduce an increase in the power consumption of the backlight associated with the incorporation of the light sensor into the image display apparatus. Further, since light signals are conveyed in the vertical (Y) and horizontal (X) directions, there is no need to perform region segmentation in the vertical (Y) direction to sequentially read out signals, and the information on a two-dimensional touched position can be obtained based on the light signals read in the vertical and horizontal directions, which leads to a reduction in detection time and thus can improve touch detection accuracy.

### Eighth Embodiment

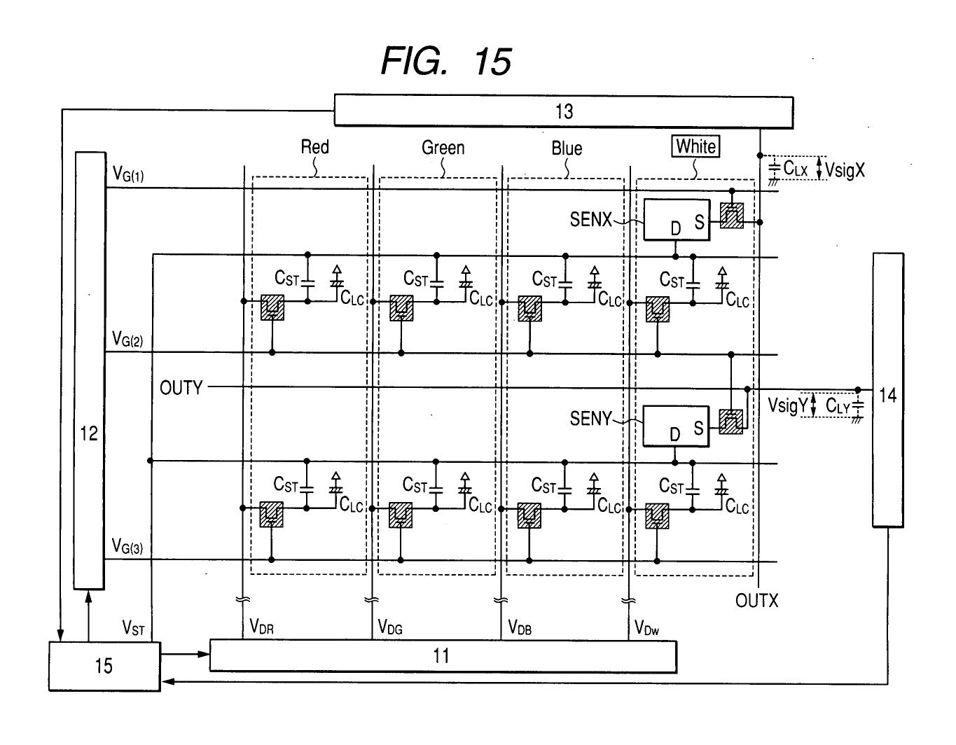

FIG. 15 is a circuit configuration diagram of the image display apparatus, according to an eighth embodiment of the invention. The eighth embodiment differs from the seventh embodiment in that switch TFTs are connected between the respective source electrodes (S) of the sensor circuits SENX and SENY and the respective signal lines OUTX and OUTY.

According to the eighth embodiment, as in the case of the seventh embodiment, the pixel structure is simplified, which can suppress a decrease in the aperture ratio of the pixel associated with the incorporation of the light sensor into the image display apparatus, and thus can reduce an increase in the power consumption of the backlight associated with the incorporation of the light sensor into the image display apparatus. Further, since light signals are conveyed in the vertical (Y) and horizontal (X) directions, there is no need to perform region segmentation in the vertical (Y) direction to sequentially read out signals, and the information on a two-dimensional touched position can be obtained based on the light signals read in the vertical and horizontal directions, which leads to a reduction in detection time and thus can improve touch detection accuracy.

### Ninth Embodiment

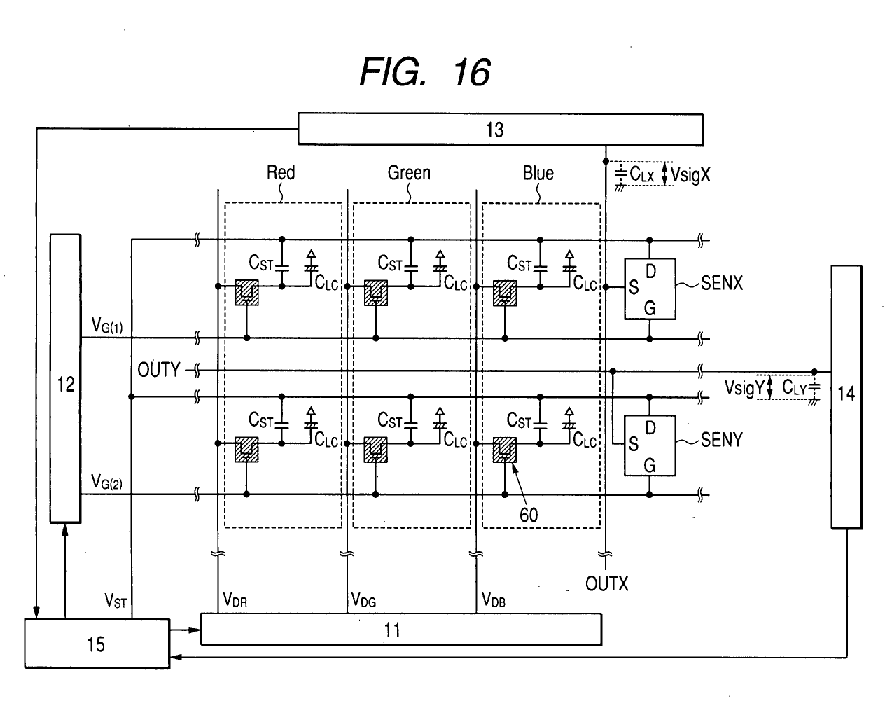

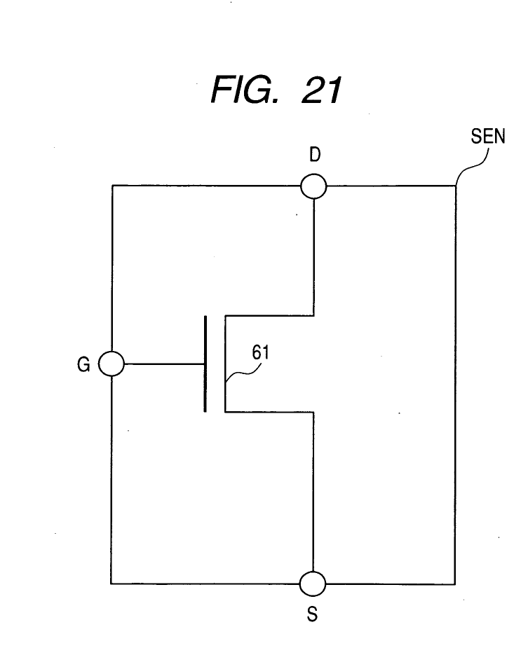

FIG. 16 is a circuit configuration diagram of the image display apparatus, according to a ninth embodiment of the invention. The ninth embodiment differs from the second embodiment only in that the sensor circuits SENX and SENY each have a gate electrode and the gate electrodes (G) of the sensor circuits SENX and SENY are connected to the gate lines V_{G(1)} and V_{G(2)} respectively. When the clock voltage of the gate line V_{G(1)} or V_{G(2)} becomes low (L), a negative bias can be applied to the gate electrode of the light detection TFT as described later in FIG. 21. The other effects of the ninth embodiment are the same as those of the second embodiment.

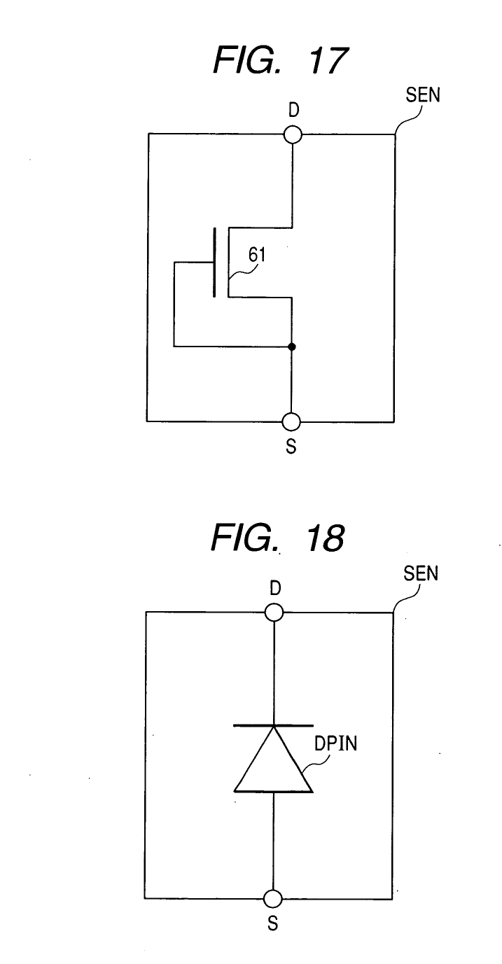

FIG. 17 is a circuit diagram illustrating a first configuration example of the horizontal and vertical sensor circuits applied to embodiments of the invention. This sensor circuit SEN is composed of the light detection TFT in a diode-connected configuration with the gate and source electrodes short-circuited, having a drain (D) terminal and a source (S) terminal.

FIG. 18 is a circuit diagram illustrating a second configuration example of the horizontal and vertical sensor circuits applied to embodiments of the invention. This sensor circuit SEN is composed of a PIN diode, having a drain (D) terminal and a source (S) terminal.

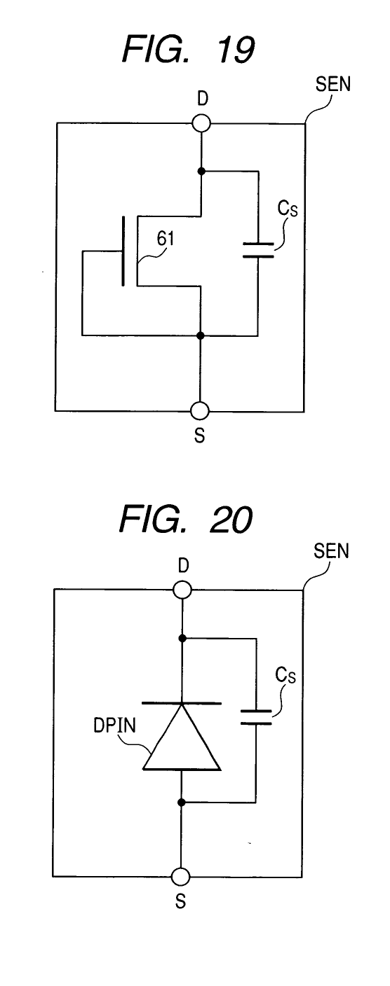

FIG. 19 is a circuit diagram illustrating a third configuration example of the horizontal and vertical sensor circuits applied to embodiments of the invention. This sensor circuit SEN is composed of the light detection TFT 61 and a storage capacitor C_{S} in parallel, having a drain (D) terminal and a source (S) terminal. Thereby, a light current Isig generated by irradiating the light detection TFT with light is charged in the storage capacitor Cs.

FIG. 20 is a circuit diagram illustrating a fourth configuration example of the horizontal and vertical sensor circuits applied to embodiments of the invention. This sensor circuit SEN is composed of a PIN diode in place of the thin-film transistor shown in FIG. 19 and a storage capacitor C_{S} in parallel, having a drain (D) terminal and a source (S) terminal.

FIG. 21 is a circuit diagram illustrating a fifth configuration example of the horizontal and vertical sensor circuits applied to embodiments of the invention. This sensor circuit SEN is composed of the light detection TFT 61, having a drain (D) terminal, a gate (G) terminal, and a source (S) terminal.

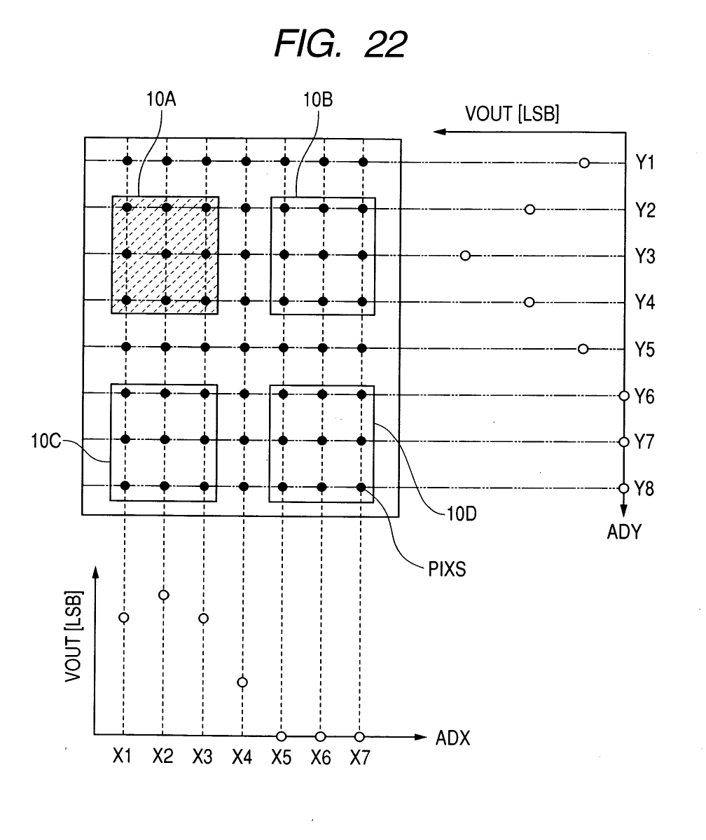

FIG. 22 is an explanatory view illustrating a display screen with a touch panel for use on the image display apparatus according to the invention. In FIG. 22, for the convenience of description, sensor circuits of 7 (addresses X1 to X7)×8 (addresses Y1 to Y8) pixels are arranged, and four touch buttons (10A, 10B, 10C, 10D) are shown. Each touch button has a detection area including nine sensor circuits.

Four (2×2) touch buttons are displayed on the display screen, and an upper-left touch button is touched by a finger. FIG. 22 shows the relationship between addresses and the outputs VOUTX and VOUTY of the X address detection circuit and the Y address detection circuit. The vertical axis indicates the digital output VOUTX or VOUTY of the X or Y address detection circuit, which is the gradation value. The horizontal axis indicates the address. The outputs reach their peaks at address (X2, Y3). This is because touch reflected light LREF becomes largest at the center of the area touched by the finger so as to generate the corresponding light current Isig. Thus, the gradation representation of output values of the matrix-arranged sensor circuits enables finger touching to be determined with high accuracy. It is also possible to distinguish finger touching from irradiation of ambient light on the image display apparatus during no finger touching.

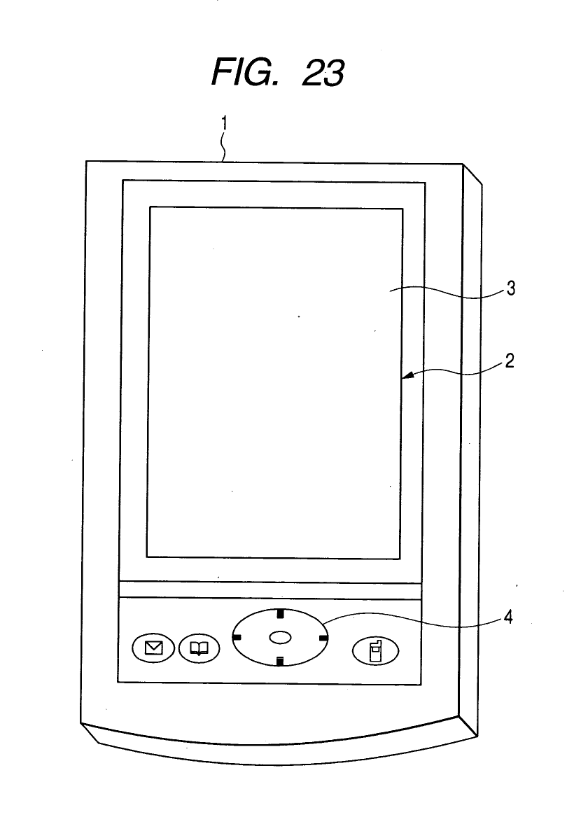

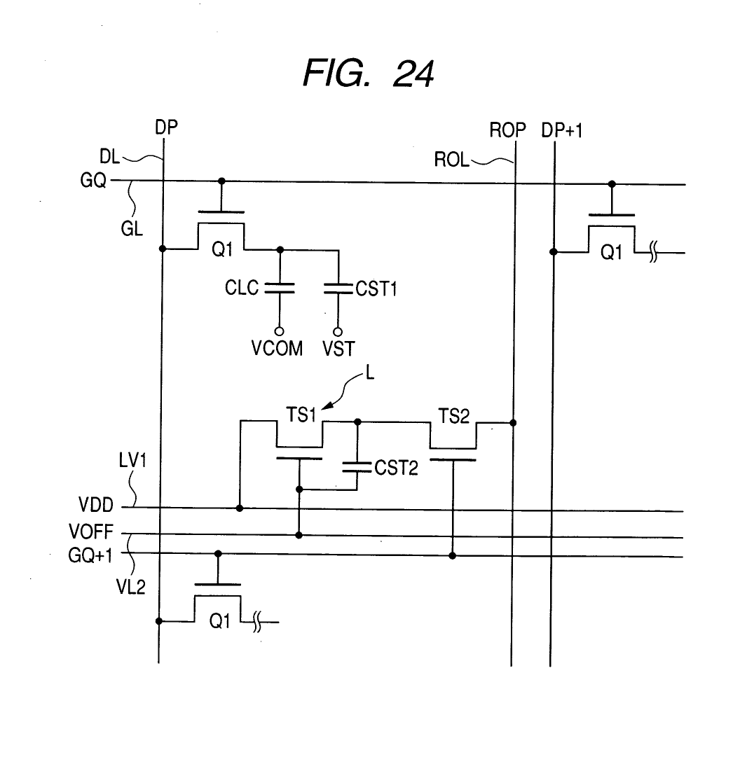

FIG. 23 is a schematic external view showing a mobile electronic device to which the image display apparatus according to the invention is applied. The mobile electronic device 1 is equipped with a cross key 4 as well as the image display apparatus 2 according to the invention. By applying the image display apparatus 2 of the invention to the mobile electronic device 1, when a user's finger touches an icon or the like displayed on the display screen 3 of the image display apparatus 2, an operation instruction can be issued. This enables a user interface for the touch panel function of selection processing, without having a conventional touch panel module mounted thereon.

In the above description, the invention is applied to the liquid crystal display device. However, the invention is also applicable to other types of image display apparatuses using TFT substrates described in the above embodiments, e.g., an organic EL display device. In the case of the organic EL display device, a bank for defining the aperture of a pixel is formed, with a pixel electrode being one electrode. In an inside area surrounded by the bank, the other electrode is formed over an organic EL luminescent layer laminated on the one electrode. The bank is formed of a light-absorbing insulating material to have the function of a black matrix.

In the case of the organic EL display device, in the series circuit composed of the switch TFT and the light detection TFT on the TFT substrate, the switch TFT is formed in an area shaded by the bank and the light detection TFT is disposed in the aperture of the pixel so as to perform the same operation as the liquid crystal display device. The generation of a detection signal and the sensor signal processing for generating a determination signal are the same as described in the above embodiments.

What is claimed is:

1. An image display apparatus with image entry function in which information is inputted by a touch on a pixel area of a screen formed over an insulating substrate, the image display apparatus with image entry function comprising:
each pixel in the pixel area composed of a plurality of pixels constituting the screen, including a first thin-film transistor for use as a pixel switch which is shaded from irradiation of light incident through the screen, a second thin-film transistor for use as a light sensor which receives the light, a storage capacitor, and a pixel electrode, on a principal surface of the insulating substrate;
a drain electrode or a source electrode of the first thin-film transistor being connected to a source electrode or a drain electrode of the second thin-film transistor;
the drain electrode or the source electrode of the second thin-film transistor being connected to one electrode of the storage capacitor and the pixel electrode;
a gate line for pixel selection connected to a gate electrode of the first thin-film transistor;
a sensor control line connected to a gate electrode of the second thin-film transistor;
a data line connected to the source electrode or the drain electrode of the first thin-film transistor; and
a storage line connected to the other electrode of the storage capacitor,
wherein the data line and the storage line convey a display signal to be applied to the pixel electrode and a sense signal of the second thin-film transistor.

2. The image display apparatus with image entry function according to claim 1, further comprising a selector switch, connected to respective one ends of the data line and the storage line, for switching conveyance of the display signal and the sense signal.

3. The image display apparatus with image entry function according to claim 1, further comprising:
an X address detection circuit which receives sense signals of second thin-film transistors arranged in a vertical direction in the pixel area through the data line; and
a Y address detection circuit which receives sense signals of second thin-film transistors arranged in a horizontal direction in the pixel area through the storage line.

4. The image display apparatus with image entry function according to claim 1, further comprising a control circuit which determines presence or absence of a touch and extracts a position address thereof, based on an output of the X address detection circuit and an output of the Y address detection circuit.

5. An image display apparatus with image entry function in which information is inputted by a touch on a pixel area of a screen formed over an insulating substrate, the image display apparatus with image entry function comprising:
each pixel in the pixel area composed of a plurality of pixels constituting the screen, including a thin-film transistor for use as a pixel switch which is shaded from irradiation of light incident through the screen, a plurality of sub-pixels arranged in a horizontal direction in which a source electrode or a drain electrode of the thin-film transistor is connected to one electrode of a storage capacitor and a pixel electrode, an X address sensor circuit which is disposed at one location to the plurality of sub-pixels adjacent in a vertical direction and receives the light, and a Y address sensor circuit which is disposed at another location and receives the light, on a principal surface of the insulating substrate;
a gate line for pixel selection connected to a gate electrode of the thin-film transistor for use as the pixel switch;
a data line connected to the source electrode or the drain electrode of the thin-film transistor for use as the pixel switch;
a storage line connected to the other electrode of the storage capacitor;
the X address sensor circuit and the Y address sensor circuit being each composed of a thin-film transistor, and a drain electrode or a source electrode of each thin-film transistor being connected to the storage line;
an X address output line connected to the source electrode or the drain electrode of the thin-film transistor of the X address sensor circuit;
a Y address output line connected to the source electrode or the drain electrode of the thin-film transistor of the Y address sensor circuit;
an X address detection circuit connected to one end of the X address output line; and
a Y address detection circuit connected to one end of the Y address output line.

6. The image display apparatus with image entry function according to claim 5, wherein the number of sub-pixels arranged in the horizontal direction is three, and the three sub-pixels correspond to red, green, and blue constituting full-color display, respectively.

7. The image display apparatus with image entry function according to claim 6, wherein the X address sensor circuit and the Y address sensor circuit are disposed adjacent to a blue sub-pixel adjacent in the vertical direction.

8. The image display apparatus with image entry function according to claim 5, wherein the number of sub-pixels arranged in the horizontal direction is four, and the four sub-pixels respectively correspond to red, green, and blue constituting full-color display, and white.

9. The image display apparatus with image entry function according to claim 8, wherein the X address sensor circuit and the Y address sensor circuit are disposed adjacent to a white sub-pixel adjacent in the vertical direction.

10. The image display apparatus with image entry function according to claim 5, wherein a switch is disposed between the X address sensor circuit and the X address output line and between the Y address sensor circuit and the Y address output line.

11. The image display apparatus with image entry function according to claim 10, wherein the switch is a thin-film transistor whose gate electrode is connected to the gate line, and an output of the X address sensor circuit and an output of the Y address sensor circuit are outputted to the X address output line and the Y address output line at timing selected through the gate line.

12. The image display apparatus with image entry function according to claim 6, wherein the red, green, and blue corresponding to the sub-pixels are formed in a stripe arrangement.

13. The image display apparatus with image entry function according to claim 6, wherein the red, green, and blue corresponding to the sub-pixels are formed in a mosaic arrangement.

14. The image display apparatus with image entry function according to claim 5, wherein the X address sensor circuit and the Y address sensor circuit are disposed adjacent to a red sub-pixel, a green sub-pixel, and a blue sub-pixel adjacent in the vertical direction and disposed outside respective color filters which cover the sub-pixels.

15. The image display apparatus with image entry function according to claim 5, wherein each of the X address sensor circuit and the Y address sensor circuit is composed of a PIN diode and has a drain terminal and a source terminal.

16. The image display apparatus with image entry function according to claim 5, wherein each of the X address sensor circuit and the Y address sensor circuit is composed of a thin-film transistor and has a drain terminal, a gate terminal, and a source terminal.

17. The image display apparatus with image entry function according to claim 16, wherein the gate and source terminals of the thin-film transistor are short-circuited.

18. The image display apparatus with image entry function according to claim 16, wherein a capacitor is connected in parallel between the drain and source terminals of the thin-film transistor.

19. The image display apparatus with image entry function according to claim 15, wherein a capacitor is connected in parallel between the drain and source terminals of the PIN diode.

20. The image display apparatus with image entry function according to claim 5, wherein each of the X address sensor circuit and the Y address sensor circuit is composed of a thin-film transistor and has a drain terminal, a gate terminal, and a source terminal, and the gate line for pixel selection is connected to the gate terminal.
